(19) United States
(12) Patent Application Publication
(10) Pub. No.: US 2023/0131048 A1
(43) Pub. Date: Apr. 27, 2023

(54) METHOD FOR MANUFACTURING SUSPENSION ARM FOR VEHICLE

(71) Applicant: ILJIN CO., LTD., Gyeongju-si Gyeongsangbuk-do (KR)

(72) Inventors: Se Woong JEONG, Ulsan (KR); Ig Jin KWON, Daegu (KR); Hyun Tae BANG, Incheon (KR); Ki Ho KIM, Cheongju-si, Chungcheongbuk-do (KR); Hwan Soo SONG, Seoul (KR)

(73) Assignee: ILJIN CO., LTD., Gyeongju-si Gyeongsangbuk-do (KR)

(21) Appl. No.: 17/789,375

(22) PCT Filed: Dec. 28, 2020
(86) PCT No.: PCT/KR2020/019238

§ 371 Date: Jan. 10, 2023

(30) Foreign Application Priority Data
Dec. 27, 2019 (KR) 10-2019-0177181

(51) Int. Cl. B60G 7/00; B29B 11/14; B21J 5/02

(52) U.S. Cl. CPC B60G 7/001; B29B 11/14; B21J 5/02; B60G 2206/7102; B60G 2206/81022

(57) ABSTRACT

There is provided a method of manufacturing a suspension arm for a vehicle. The method includes a preform forming operation of forming a preform as a preliminary molding object for forming the suspension arm for a vehicle; and a main-molding-object forming operation of hot-pressing the preform to form a main molding object for forming the suspension arm for a vehicle. The preform formed in the preform forming operation may be formed in a shape corresponding to a shape of the main molding object, and may be formed in a shape offset inward from an outer shape of the main molding object by a predetermined dimension.

### CROSS-REFERENCE TO RELATED APPLICATIONS

This application is a national phase of International Application No. PCT/KR2020/019238 filed on Dec. 28, 2020, which claims priority to Korean Patent Application No. 10-2019-0177181 filed on Dec. 27, 2019, the entire contents of which are herein incorporated by reference.

### TECHNICAL FIELD

The present disclosure relates to a method of manufacturing a suspension arm constituting a suspension device of a vehicle, and more particularly to a method of manufacturing a suspension arm for a vehicle constituted so that productivity and rigidity are improved by manufacturing a suspension arm using a pre-molded preform.

The present disclosure has been derived from a study conducted as Carbon Industry Foundation Development Project of Korea Evaluation Institute of Industrial Technology of Ministry of Trade, Industry and Energy [Project Number: 10083624, Research Subject Name: Development of suspension module for a vehicle using rapid curing carbon composite material high speed molding technology]

### BACKGROUND

A suspension device of a vehicle is a device for connecting a wheel to a vehicle body, and includes a spring for absorbing vibration or impact transferred from a road surface to the vehicle body, a shock absorber for controlling the operation of the spring, a suspension arm or a suspension link for controlling the operation of the wheel, and the like.

Among these, the suspension arm is configured such that one side thereof is connected to a wheel-side member via a ball joint and another side thereof is connected to a vehicle-body-side member such as a cross member, a sub-frame or the like. The suspension arm supports the wheel on the vehicle body and properly controls toe-in of the wheel according to a driving situation of the vehicle, thereby improving straight driving property and steering stability of the vehicle.

Typically, such a suspension arm for a vehicle has been formed by casting or press-machining metal-based material to ensure the rigidity required for the suspension arm. However, in recent years, various studies have been conducted to improve material and structure of the suspension arm with increased demands for lightweight of components for a vehicle.

As an example, Patent Document 1 discloses a technique for manufacturing a suspension arm for a vehicle using carbon fiber reinforced plastic (CFRP) material.

For example, as illustrated in FIG. 1, a suspension arm for a vehicle 10 (for example, a lower arm) disclosed in Patent Document 1 is formed in a structure in which mounting portions (for example, a wheel-side mounting portion 30 on which a B-bushing 60 is mounted, a vehicle-body-side mounting portion 40 on which a G-bushing 70 is mounted, a vehicle-body-side mounting portion 50 on which an A-bushing 80 is mounted, and the like) used for connecting a suspension arm to a wheel-side member or a vehicle-body-side member are provided on one end portion of a body portion 20 constituting a main frame. The suspension arm 10 may be formed by filling a mold with carbon fiber reinforced plastic material such as carbon chip, and then performing a hot-pressing on the material.

On the other hand, in order to improve the productivity of the suspension arm for a vehicle, the suspension arm for a vehicle 10 disclosed in Patent Document 1 is manufactured by: forming a wheel-side mounting portion 30 on which a B-bushing is mounted, a vehicle-body-side mounting portion 50 on which an A-bushing is mounted, and the like, in the form of a preform having a predetermined shape as illustrated in FIG. 2; inserting such preforms into a mold; filling carbon fiber-reinforced plastic material such as carbon chip into the mold; and performing a hot-pressing on the material.

However, in the suspension arm for a vehicle 10 (a lower arm) manufactured in this way, a portion formed by the preform may be hardened earlier than other portions. This makes the strength of the suspension arm for a vehicle 10 ununiform depending on a position. In addition, a coupling force between the portion formed by the preform and the portion formed by supplementing additional material such as carbon chip may be weakened, thereby reducing the rigidity of the suspension arm for a vehicle 10.

In addition, a process of filling the material such as the carbon chip into the mold to perform the hot-pressing is performed in a manual manner and thus takes a long period of processing time. In the case of the above-mentioned manufacturing method in the related art, it is necessary to perform the process of filling the carbon chip material into the mold twice at the time of manufacturing the preform and at the time of manufacturing a main molding object of the suspension arm for a vehicle. This may reduce the overall productivity of the suspension arm for a vehicle.

### Document in Related Art

Patent Document 1: Korean Patent Application Publication No. 10-2019-0030010 (Publication Date: Mar. 21, 2019)

### SUMMARY

The present disclosure was made in view of the above-mentioned matters in the suspension arm, and the present disclosure is for the purpose of providing a method of manufacturing a suspension arm for a vehicle which is capable of manufacturing a suspension arm for a vehicle in a faster and easier manner by one material filling operation using a preform previously formed in a shape corresponding to the suspension arm for a vehicle to be manufactured (specifically, in a shape slightly offset by a predetermined amount from the suspension arm for a vehicle to be manufactured), and capable of ensuring uniform rigidity as a whole.

Representative configurations of the present disclosure for achieving the above aspects are described below.

According to an example embodiment of the present disclosure, there is provided a method of manufacturing a suspension arm for a vehicle. The method according to an example embodiment of the present disclosure may comprise a preform forming operation of forming a preform as a preliminary molding object for forming the suspension arm for a vehicle; and a main-molding-object forming operation of hot-pressing the preform to form a main molding object for forming the suspension arm for a vehicle, wherein the preform formed in the preform forming operation may be formed in a shape corresponding to a shape of the main molding object, and may be formed in a shape offset inward from an outer shape of the main molding object by a predetermined dimension.

According to an example embodiment of the present disclosure, the preform formed in the preform forming operation may be formed in a shape offset inward from the outer shape of the main molding object by 1 mm to 3 mm.

According to an example embodiment of the present disclosure, the preform formed in the preform forming operation may be formed thicker than the main molding object by a predetermined dimension.

According to an example embodiment of the present disclosure, the preform formed in the preform forming operation may be formed thicker than the main molding object by 1 mm to 3 mm.

According to an example embodiment of the present disclosure, the preform forming operation may comprise a preform-mold preparation operation of preparing a preform mold in which a recess having a shape corresponding to a shape of the preform; a material filling operation of filling material for forming the preform into the recess of the preform mold; a preform molding operation of molding the material filled into the recess of the preform mold to form the preform; and a preform separating operation of separating the molded preform from the preform mold.

According to an example embodiment of the present disclosure, in the material filling operation, a same amount of material as material necessary for forming the main molding object may be filled into the recess of the preform mold.

According to an example embodiment of the present disclosure, the material filled into the recess of the preform mold to form the preform in the material filling operation may be carbon chip material.

According to an example embodiment of the present disclosure, the main-molding-object forming operation may comprise: a main-molding-object mold preparation operation of preparing a main-molding-object mold in which a recess having a shape corresponding a shape of the main molding object; a preform insertion operation of inserting the preform into the recess of the main-molding-object mold; a hot-pressing operation of hot-pressing the preform inserted into the recess of the main-molding-object mold to form the main molding object; and a main-molding-object separating operation of separating the hot-pressed main molding object from the main-molding-object mold.

According to an example embodiment of the present disclosure, the main molding object may be formed in a structure that one or more of a plurality of mounting portions, which are used to connect the suspension arm for a vehicle to a wheel-side member or a vehicle-body-side member, are integrally formed with a body portion constituting a main frame of the suspension arm for a vehicle.

According to an example embodiment of the present disclosure, the method may further comprise a mounting-portion coupling operation of coupling a mounting portion(s), not integrally formed with the body portion of the main molding object, to the body portion.

According to an example embodiment of the present disclosure, the mounting portion not integrally formed with the body portion of the main molding object may comprise a bushing coupling portion and a fastening portion formed to extend from the bushing coupling portion to one side, and the fastening portion may be coupled to the coupling portion in surface-contact with the coupling portion provided in the body portion of the main molding object.

According to an example embodiment of the present disclosure, a slip prevention portion(s) configured to prevent a slip of the fastening portion relative to the coupling portion may be provided between the fastening portion and the coupling portion.

According to an example embodiment of the present disclosure, the mounting portion comprising the bushing coupling portion and the fastening portion may be formed of metallic material.

According to an example embodiment of the present disclosure, the mounting portion comprising the bushing coupling portion and the fastening portion may be formed of aluminum material.

According to an example embodiment of the present disclosure, the method may further comprise a post-processing operation of performing a subsequent process(es) necessary for the main molding object after the main-molding-object forming operation.

Further, the suspension arm for a vehicle manufacturing method according to the present disclosure may further include other additional configurations without departing from the technical sprit of the present disclosure.

A method of manufacturing a suspension arm for a vehicle according to an example embodiment of the present disclosure is configured to form a suspension arm for a vehicle by forming a preform having a shape corresponding to a shape of the suspension arm for a vehicle to be manufactured in advance, and subsequently performing a hot-pressing on the preform. This configuration makes it possible to quickly and easily manufacture the suspension arm for a vehicle. Further, a body portion of the suspension arm for a vehicle is entirely formed by the hot-pressing. This configuration makes the rigidity of the suspension arm for a vehicle uniform as a whole.

Furthermore, a method of manufacturing a suspension arm for a vehicle according to an example embodiment of the present disclosure is configured to form a preform as a preliminary molding object using a same amount of material (for example, carbon-based material such as carbon chip) as material necessary for forming a main molding object. This eliminates a need to fill an additional material into a mold in a process of forming the main molding object with the preform, which shortens a processing time required for such a material filling operation and further improves the efficiency of a suspension arm manufacturing process.

In addition, a method of manufacturing a suspension arm for a vehicle according to an example embodiment of the present disclosure is configured such that a preform as a preliminary molding object is formed in a shape offset inward from an outer shape of the main molding object by a predetermined dimension. This makes it possible to easily insert the preform into a mold without any interference when the preform is inserted into a main-molding-object mold to form the suspension arm for a vehicle. As a result, the suspension arm manufacturing process may be more quickly and easily performed.

### BRIEF DESCRIPTION OF THE DRAWINGS

FIG. 1 exemplarily illustrates an example of a suspension arm for a vehicle known in the related art.

FIG. 2A exemplarily illustrates a preform of a wheel-side mounting portion and FIG. 2B exemplarily illustrates a preform of a vehicle-body-side mounting portion, which may be used to manufacture the suspension arm for a vehicle illustrated in FIG. 1, respectively.

FIG. 3 exemplarily illustrates an overall structure of a suspension arm for a vehicle according to an example embodiment of the present disclosure.

FIG. 4 exemplarily illustrates an exploded perspective view of the suspension arm for a vehicle according to an example embodiment of the present disclosure.

FIG. 5 exemplarily illustrates a body portion of the suspension arm for a vehicle according to an example embodiment of the present disclosure.

FIG. 6 exemplarily illustrates a structure of a coupling portion provided in the body portion of the suspension arm for a vehicle according to an example embodiment of the present disclosure.

FIG. 7 exemplarily illustrates a structure of a mounting portion which is formed separately from the body portion and coupled to the body portion in the suspension arm for a vehicle according to an example embodiment of the present disclosure.

FIG. 8 exemplarily illustrates a state of the mounting portion illustrated in FIG. 7 when viewed from a front side.

FIG. 9 exemplarily illustrates a structure of a suspension arm for a vehicle according to another example embodiment of the present disclosure (for the sake of convenience in description, fastening members will be omitted).

FIG. 10 exemplarily illustrates a method for manufacturing a suspension arm for a vehicle according to an example embodiment of the present disclosure.

FIGS. 11A and 11B schematically illustrate a shape of a preform and a main molding object used to manufacture the suspension arm for a vehicle according to an example embodiment of the present disclosure.

FIG. 12 exemplarily illustrates a process of forming the preform in the method of manufacturing the suspension arm for a vehicle according to an example embodiment of the present disclosure.

FIG. 13 schematically illustrates a state in which the preform is formed in the method of manufacturing the suspension arm of a vehicle according to an example embodiment of the present disclosure.

FIG. 14 exemplarily illustrates a process of forming the main molding object using the preform in the method of manufacturing the suspension arm for a vehicle according to an example embodiment of the present disclosure.

FIG. 15 schematically illustrates a state in which the main molded body is formed using the preform in the method of manufacturing the suspension arm for a vehicle according to an example embodiment of the present disclosure.

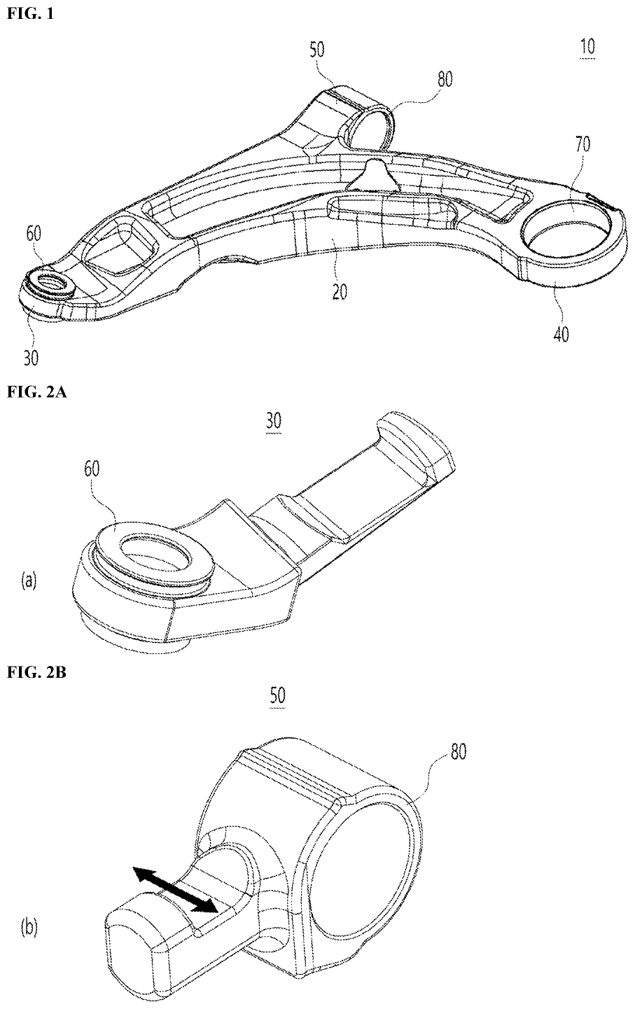

### EXPLANATION OF REFERENCE NUMERALS

100: Suspension arm for vehicle
200: Body portion
210: Coupling portion
220: Slip prevention portion (formed in coupling portion of body portion)
222: Upper protrusion portion
224: Lower recess
230: Through-hole
240: Through-hole (formed in body portion)
310: First mounting portion
320: Second mounting portion
330: Third mounting portion
340: Bushing coupling portion
350: Fastening portion
360: Upper plate
370: Lower plate
380: Slip prevention portion
382: Upper recess
384: Lower protrusion portion
390: Fastening hole
400: Fastening member (for example, locking pin)

### DETAILED DESCRIPTION

Hereinafter, example embodiments of the present disclosure will be described in detail with reference to the accompanying drawings at such an extent that they may be readily practiced by those ordinary skilled in the art.

In order to clearly describe the present disclosure, descriptions of parts irrelevant to the present disclosure will be omitted, and the same/similar reference numerals will be given to the same/similar constituent elements throughout the specification. Further, a size, thickness and position of each constituent element illustrated in the figures are arbitrarily illustrated for the sake of convenience in description, and hence the present disclosure is not necessarily limited to those illustrated. That is, it is to be understood that specific shapes, structures, and characteristics described herein may be modified from an example embodiment to another example embodiment without departing from the spirit and scope of the present disclosure. Positions or arrangements of individual constituent elements may also be modified without departing from the spirit and scope of the present disclosure. Therefore, the detailed descriptions described below are not to be taken in a limiting sense, and the scope of the present disclosure is to be taken as covering the scope claimed by the appended claims and their equivalents.

Suspension Arm for a Vehicle According to an Example Embodiment of the Present Disclosure

Referring to the figures, a suspension arm for a vehicle 100 according to an example embodiment of the present disclosure is exemplarily illustrated. The suspension arm for a vehicle 100 according to an example embodiment of the present disclosure is configured such that a mounting portion (for example, third mounting portion 330 on which a A-point bushing is mounted) is separately formed from body portion of a suspension arm and then coupled to the body portion of the suspension arm. However, the suspension arm for a vehicle according to an example embodiment of the present disclosure is not necessarily limited to the structure illustrated in the figures. The suspension arm for a vehicle according to an example embodiment of the present disclosure may be modified another structure.

and the third mounting portion 330 to which the A-point bushing is coupled may be formed separately from the body portion 200 using a light-weight metallic material such as aluminum and then coupled to a coupling portion 210 formed on one side of the body portion 200

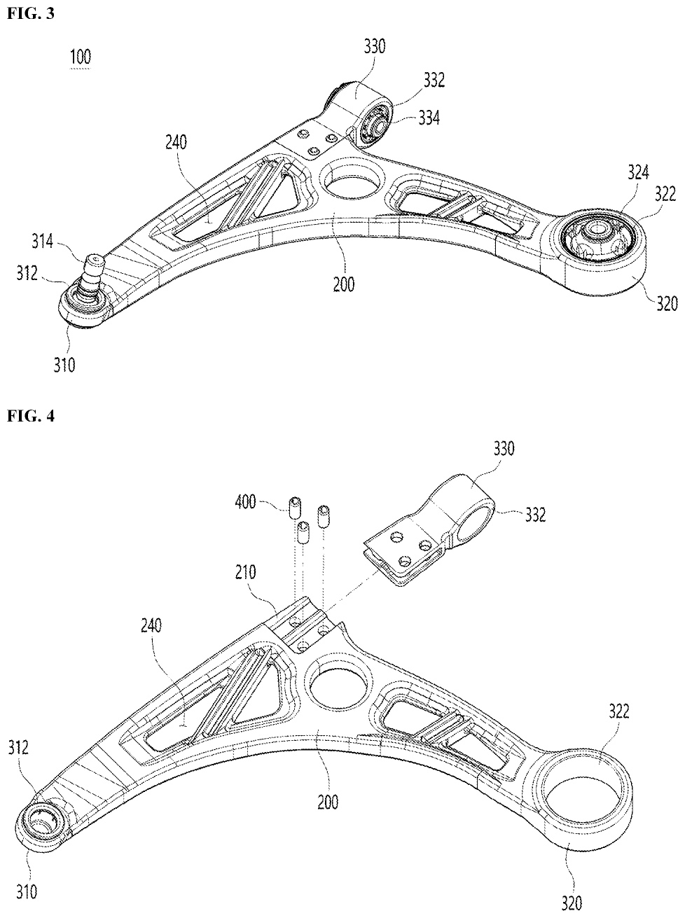

According to an example embodiment of the present disclosure, as illustrated in FIGS. 3 and 4, the suspension arm for a vehicle 100 may be configured to comprise a body portion 200 located in a central portion and mounting portions provided on one side of the body portion 200 (for example, a first mounting portion 310 connected to the wheel-side member, a second mounting portion 320 and a third mounting portion 330 connected to the vehicle-body-side member, and the like).

According to an example embodiment of the present disclosure, the body portion 200 is a portion that constitutes a basic body of the suspension arm for a vehicle 100 according to an example embodiment of the present disclosure. When the suspension arm for a vehicle 100 according to an example embodiment of the present disclosure is configured as a lower arm, the body portion 200 may be formed in a approximately L-shaped structure including two leg portions each of which extends to one side, as illustrated in FIGS. 3 and 4.

According to an example embodiment of the present disclosure, mounting portions (one or more wheel-side mounting portions and one or more vehicle-body-side mounting portions) used to connect the suspension arm for a vehicle 100 according to an example embodiment of the present disclosure to the wheel-side member or the vehicle-body-side member may be provided in one side of the body portion 200. For example, as illustrated in FIGS. 3 and 4, the mounting portions may be formed at end portions of the two leg portions constituting the body portion 200, a connection portion connecting the two leg portions, and the like.

According to an example embodiment of the present disclosure, an end portion of one of the two leg portions constituting the body portion 200 may be provided with a wheel-side mounting portion (the first mounting portion 310) used to connect the suspension arm to the wheel-side member. According to an example embodiment of the present disclosure, a B-bushing 312 may be mounted on the first mounting portion 310. A bolt joint 314 may be inserted into the B-bushing 312 mounted on the first mounting portion 310 to connect the suspension arm to the wheel-side member such as a knuckle (not illustrated).

According to an example embodiment of the present disclosure, an end portion of the other of the two leg portions constituting the body portion 200 and a connection portion between the two leg portions may be provided with vehicle-body-side mounting portions (for example, the second mounting portion 320 on which a G-bushing is mounted and the third mounting portion 330 on which a A-bushing is mounted) used to connect the suspension arm to the vehicle-body-side member. The suspension arm for a vehicle 100 according to an example embodiment of the present disclosure may be configured to be connected to the vehicle-body-side member such as a cross member, a sub-frame or the like through the vehicle-body-side mounting portions (the second mounting portion 320 and the third mounting portion 330).

According to an example embodiment of the present disclosure, the second mounting portion 320 may have a through-hole formed to penetrate the second mounting portion 320 in a direction that is approximately perpendicular to the body portion 200, and the G-bushing 322 may be inserted into and coupled to the through-hole. A G-bushing assembly 324 may be configured to be inserted into and coupled to the G-bushing 322. Through the G-bushing assembly 324, the suspension arm for a vehicle 100 according to an example embodiment of the present disclosure may be connected to the vehicle body while rotating around an axis along a substantially up-down direction of the vehicle.

According to an example embodiment of the present disclosure, the third mounting portion 330 may have a through-hole formed to penetrate the third mounting portion 330 in a direction approximately perpendicular to the G-bushing 322 of the second mounting portion 320, and the A-bushing 332 may be inserted into and coupled to the through-hole. An A-bushing assembly 334 may be inserted into and coupled to the A-bushing 332. Through the A-bushing assembly 334, the suspension arm for a vehicle 100 according to an example embodiment of the present disclosure may be connected to the vehicle body while rotating around an axis along a substantially front-back direction of the vehicle.

The structures of the mounting portions (the first mounting portion 310, the second mounting portion 320 and the third mounting portion 330) and the bushings (the B-bushing 312, the G-bushing 322, and the A-bushing 332) coupled to the respective mounting portions in the suspension arm for a vehicle 100 according to an example embodiment of the present disclosure may be implemented substantially identically or similarly to a suspension arm for a vehicle in the related art, and thus more specific descriptions thereof will be omitted herein.

Further, detailed structures of the body portion 200 and the mounting portions 310, 320 and 330 of the suspension arm for a vehicle 100 according to an example embodiment of the present disclosure are not limited to those illustrated in the figures but may be changed into other various structures as long as they may be applied to a suspension arm for a vehicle. Further, the suspension arm for a vehicle 100 according to an example embodiment of the present disclosure may be configured as an upper arm instead of the lower arm illustrated in the figures.

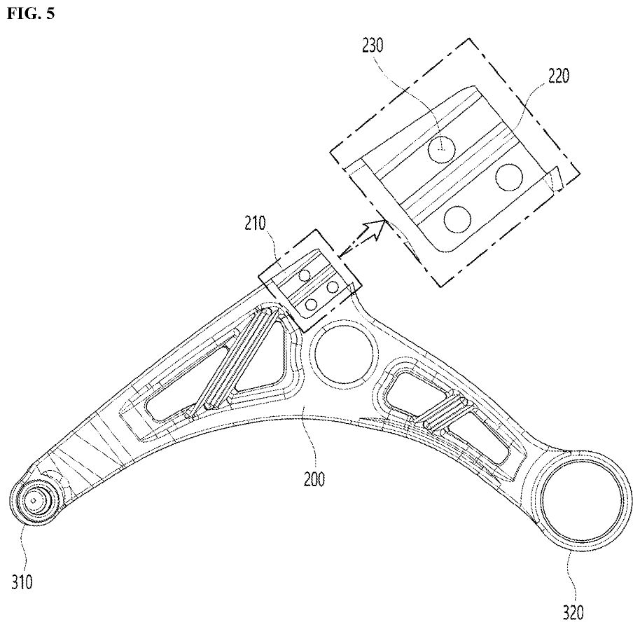

According to an example embodiment of the present disclosure, one or more of the mounting portions 310, 320 and 330 provided in the suspension arm for a vehicle 100 may be formed separately from the body portion 200 and then coupled to the body portion 200. For example, in the example embodiment described with reference to FIGS. 3 to 9, the first mounting portion 310 and the second mounting portion 320 may be formed integrally with the body portion 200 in a process of hot-pressing light-weight carbon-based material to form the body portion 200 as will be described later, and the third mounting portion 330 to which the A-bushing is coupled may be formed separately from the body portion 200 using light-weight metallic material such as aluminum and then coupled to the coupling portion 210 formed on one side of the body portion 200.

According to an example embodiment of the present disclosure, as illustrated in FIGS. 4 and 7, the third mounting portion 330 may be configured to comprise a bushing coupling portion 340 formed on one side thereof and having a through-hole into which a bushing or the like may be mounted, and a fastening portion 350 formed to extend from the bushing coupling portion 340 in one direction so as to be used to couple the third mounting portion 330 to the body portion 200.

According to an example embodiment of the present disclosure, the bushing coupling portion 340 may be formed in a substantially ring-shaped structure with an open central portion. The fastening portion 350 may be formed in a substantially U-shaped structure in which one or more coupling plates (for example, an upper plate 360 and a lower plate 370) are disposed at a predetermined interval.

According to an example embodiment of the present disclosure, the third mounting portion 330 may be configured to be coupled to the coupling portion 210 of the body portion 200 in surface-contact state via a coupling plate(s) provided to the fastening portion 350. For example, according to an example embodiment of the present disclosure, the third mounting portion 330 may be configured such that the coupling portion 210 of the body portion 200 is inserted into a space defined between the upper plate 360 and the lower plate 370 which constitute the fastening portion 350, and the upper plate 360 and the lower plate 370 of the fastening portion 350 are coupled to an upper surface and a lower surface of the coupling portion 210 in surface-contact state, respectively.

According to an example embodiment of the present disclosure, the third mounting portion 330 may be configured such that the coupling portion 210 provided on one side of the body portion 200 is slidably moved and inserted between the upper plate 360 and the lower plate 370.

According to an example embodiment of the present disclosure, the third mounting portion 330 may be configured to be guided and slidably moved by a slip prevention portion(s) provided in the fastening portion 350 of the third mounting portion 330 and/or the coupling portion 210 of the body portion 200. This configuration prevents an unintended slip (slip in a direction that intersects with the slidably moving direction) from occurring in the fastening portion 350 coupled to the coupling portion 210 by the slip prevention portion(s) after the third mounting portion 330 is coupled to the coupling portion 210 of the body portion 200.

According to an example embodiment of the present disclosure, the slip prevention portions described above may be provided on one side or both sides of the fastening portion 350 of the third mounting portion 330 and the coupling portion 210 of the body portion 200. For example, in the example embodiments illustrated in the figures, a slip prevention portion 380 formed in the fastening portion 350 of the third mounting portion 330 and a slip prevention portion 220 formed in the coupling portion 210 of the body portion 200 interact with each other to prevent an unintended slip from occurring in the fastening portion 350 after the third mounting portion 300 is coupled to the body portion 200, while supporting a slidably movable coupling between the fastening portion 350 and the coupling portion 210.

According to an example embodiment of the present disclosure, the slip prevention portions may be formed on surfaces of the fastening portion 350 of the third mounting portion 330 and the coupling portion 210 of the body portion 200, which face each other between the fastening portion 350 and the coupling portion 210. Each of the slip prevention portions may comprise a protrusion portion(s) formed to extend along a sliding movement direction between the coupling portion 210 of the body portion 200 and the fastening portion 350 of the third mounting portion 330, a recess(es) in which the protrusion portion is accommodated, and the like.

For example, in the case of the example embodiment illustrated in the figures, a protrusion portion (an upper protrusion portion 222) is formed to protrude upward from an upper surface of the coupling portion 210, and a recess (an upper recess 382) depressed upward in a shape corresponding to the upper protrusion portion 222 is formed on a lower surface of the upper plate 360, which corresponds to the upper surface of the coupling portion 210. Thus, an upper slip prevention portion (a first slip prevention portion) is formed by coupling the upper protrusion 222 and the upper recess 382. Further, a protrusion portion (a lower protrusion portion 222) is formed to protrude upward from an upper surface of the lower plate 370, and a recess (a lower recess 224) depressed upward in a shape corresponding to the lower protrusion portion 384 is formed on a lower surface of the coupling portion 210, which corresponds to the upper surface of the lower plate 370. Thus, a lower slip prevention portion (a second slip prevention portion) is formed.

With this configuration, when the third mounting portion 330 is coupled to the body portion 200, the protrusion portion extending in one direction and the recess corresponding thereto are coupled to each other so that the fastening portion 350 of the third mounting portion 330 may be smoothly slidably moved and coupled to the coupling portion 210 of the body portion 200 while being guided along the extension direction of the slip prevention portion. After the coupling, a slip in a direction intersecting with the sliding movement direction is prevented by the coupling of the protrusion portion and the recess which correspond to each other. Thus, stable rigidity may be secured near the mounting portion.

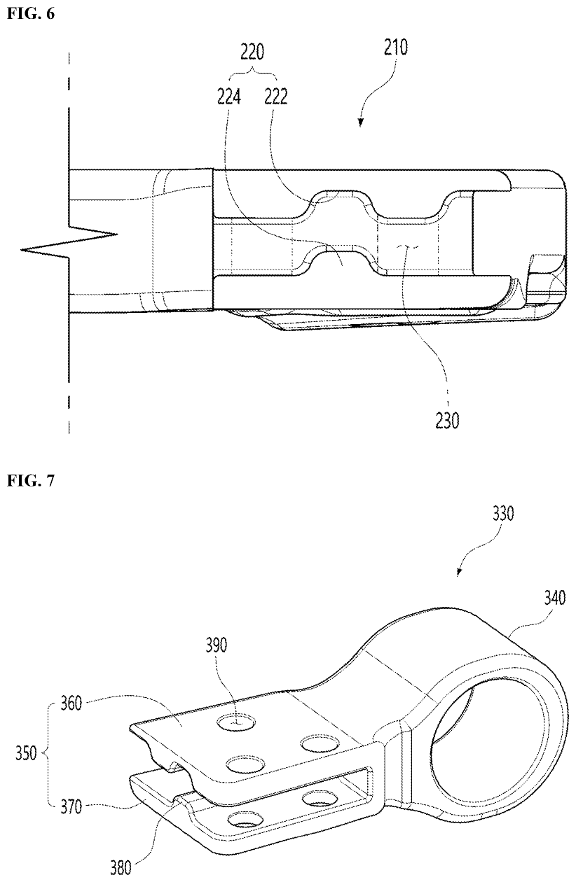

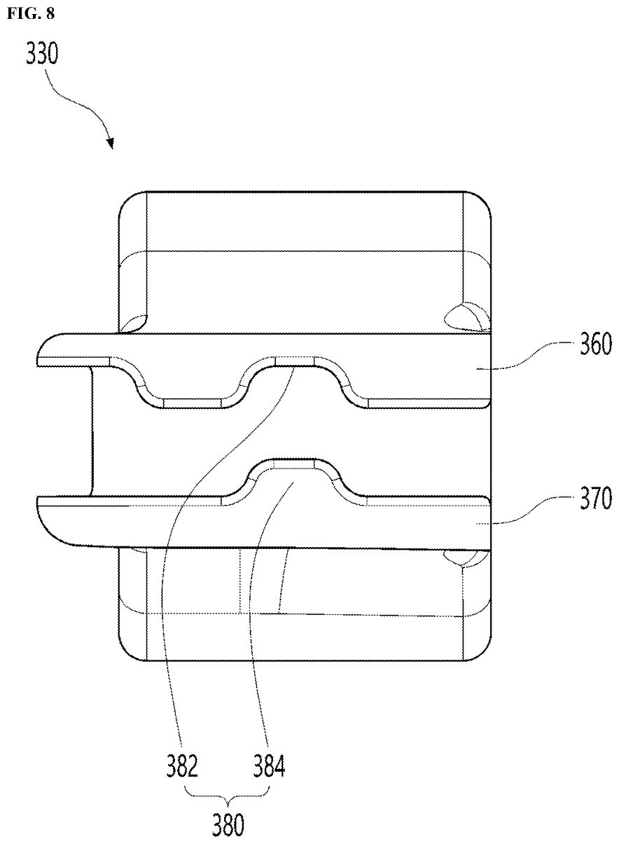

According to an example embodiment of the present disclosure, as illustrated in FIGS. 6 and 8, the first slip prevention portion and the second slip prevention portion described above may be positioned so as to overlap each other in a direction perpendicular to the coupling plates (the upper plate and the lower plate) of the fastening portion 350 when viewed in a direction in which the fastening portion 350 is slidably coupled.

As described above, when the first slip prevention portion and the second slip prevention portion are formed at positions overlapping each other, as in the example embodiments illustrated in the figures, the coupling portion 210 of the body portion 200 on which the fastening portion 350 is mounted may be formed at an uniform thickness as a whole as illustrated in FIG. 6 even if the protrusion portion is formed on the upper surface of the coupling portion 210 and the recess is formed on the lower surface of the coupling portion 210. This makes it possible to further achieve a structural stability of the suspension arm.

However, the slip prevention portion of the suspension arm for a vehicle 100 according to an example embodiment of the present disclosure is not necessarily formed by being limited to the structures illustrated in the figures. The slip prevention portions may be formed in other various forms as long as it may perform a function of preventing a slip in a direction intersecting with the sliding movement direction while guiding the slidable movement of the fastening portion 350. For example, the slip prevention portion may be formed on one of upper and lower sides of the coupling portion. Alternatively, the slip prevention portion may be configured such that the protrusion portion and the recess are formed in directions opposite to those illustrated in the figures. Alternatively, all the protrusion portions may be formed in the coupling portion of the body portion unlike the structures illustrated in the figures.

According to an example embodiment of the present disclosure, one or more fastening members 400 may be further coupled to the fastening portion 350 of the third mounting portion 330 and the coupling portion 210 of the body portion 200 to enhance a fastening force between the third mounting portion 330 and the body portion 200. For example, in the case of the example embodiment illustrated in the figures, one or more fastening holes 390 are formed in the upper plate 360 and the lower plate 370 of the third mounting portion 300, and through-holes 230 are formed at corresponding positions of the coupling portion 210 in shapes corresponding to the fastening holes 390, respectively. The fastening members 400 (for example, locking pins) are inserted into the fastening holes 390 and the through-holes 230, respectively, so that a fastening force between the third mounting portion 330 and the body portion 200 is enhanced.

According to an example embodiment of the present disclosure, the fastening members 400 may be rod-shaped locking pins, spring pins of a substantially C-shaped structure in which one side is cut out in an axial direction, or the like (see FIG. 4). The fastening members 400 may be mounted in a press-fitting manner in a direction substantially perpendicular to the fastening portion 350 of the third mounting portion 330 and the coupling portion 210 of the body portion 200 on which the fastening portion 350 is mounted. This supports the fastening between the third mounting portion 330 and the body portion 200.

Further, according to an example embodiment of the present disclosure, the body portion 200 of the suspension arm described above and the third mounting portion 330 (the bushing coupling portion 340 and the fastening portion 350) that is coupled to the body portion 200, may be formed of different materials. For example, the body portion 200 may be formed of a first material including light-weight carbon-based material, and the third mounting portion 330 may be formed of a second material different from the first material (for example, light-weight metallic material such as aluminum).

As described above, since the suspension arm for a vehicle 100 according to an example embodiment of the present disclosure is formed with the light-weight material, a weight of the suspension arm for a vehicle 100 may be reduced compared to a suspension arm for a vehicle in the related art. Further, since the coupling structure between the mounting portion and the body portion is improved, it is possible to stably secure a rigidity condition required for the suspension arm for a vehicle.

In the above-described example embodiment, the suspension arm for a vehicle 100 according to an example embodiment of the present disclosure has been described by taking, as an example, the configuration in which the third mounting portion 330 to be coupled to the vehicle-body-side member is formed separately from the body portion 200 and is coupled to the body portion 200 through the coupling portion 210 formed in the body portion 200. However, the coupling structure between the body portion and the mounting portion described above may be also applied to the first mounting portion 310 and/or the second mounting portion 320 instead of or together with the third mounting portion 330.

That is, the suspension arm for a vehicle 100 according to an example embodiment of the present disclosure may be formed such that at least one of the plurality of mounting portions 310, 320 and 330 used to connect the suspension arm for a vehicle to the wheel-side member or the vehicle-body-side member has the above-described coupling structure.

For example, referring to FIG. 9, an example embodiment is illustrated by way of example in which all of the plurality of mounting portions 310, 320 and 330 used to connect the suspension arm for a vehicle 100 to the wheel-side member or the vehicle-body-side member are formed in the same manner as the third mounting portion 330 in the above-described example embodiment.

That is, in the suspension arm for a vehicle 100 of the example embodiment illustrated in FIG. 9, all of the first mounting portion 310, the second mounting portion 320 and the third mounting portion 330 may be formed separately from the body portion 200, and subsequently, be coupled to the coupling portion 210 (210a, 210b and 210c) of the body portion 200. Each of the first mounting portion 310, the second mounting portion 320 and the third mounting portion 330 may be provided with a mounting portion 350 including the bushing coupling portion 340 and a coupling plate(s), and may be coupled to the coupling portion 210 of the body portion 200 in surface-contact state through the coupling plate(s). A slip prevention portion(s) may be provided between the mounting portion 350 and the coupling portion 210.

In the example embodiment illustrated in FIG. 9, structures of the first mounting portion 310, the second mounting portion 320 and the third mounting portion 330, and the coupling portion 210 to which these mounting portions are coupled, may be formed in substantially the same or similar manner as those in the above-described example embodiments, and thus detailed descriptions thereof will be omitted.

In the example embodiment illustrated in FIG. 9, the third mounting portion 330 is configured such that the slip prevention portions provided in the fastening portion 350 and the coupling portion 210 are formed along a direction substantially parallel to the direction in which the fastening portion 350 extends from the bushing coupling portion 340 of the third mounting portion 330. In contrast, the slip prevention portions provided in the first mounting portion 310, the second mounting portion 320 and the coupling portion 210 to which the first mounting portion 310 and the second mounting portion 320 are coupled, are formed along a direction substantially perpendicular to a direction in which the fastening portion 350 extends from the bushing coupling portion 340. This point is a difference between the example embodiment illustrated in FIG. 9 and the above-described example embodiments.

In the example embodiment illustrated in FIG. 9, the structure of the slip prevention portion is formed as described above in consideration of a direction of the load mainly applied to the vicinity of the mounting portion, but the formation direction and structure of the slip prevention portions may be appropriately changed by those skilled in the art according to specific design conditions of the suspension arm.

Method of Manufacturing Suspension arm for a vehicle according to Example Embodiment of Present Disclosure

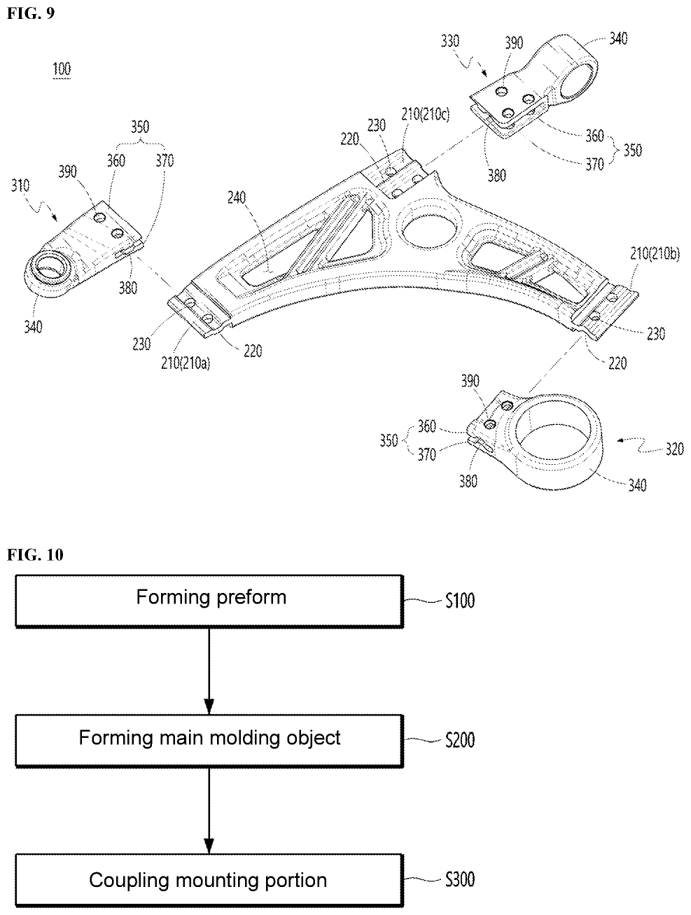

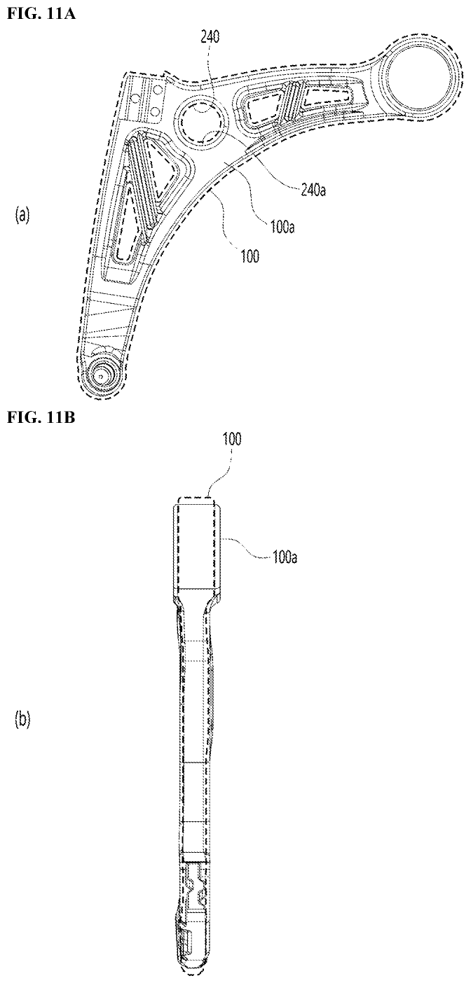

Next, a method of manufacturing the suspension arm for a vehicle 100 according to an example embodiment of the present disclosure will be exemplarily described with reference to FIGS. 10 to 15. As will be described later, the method of manufacturing the suspension arm for a vehicle according to an example embodiment of the present disclosure is configured to form a preform having a shape corresponding to a shape of the suspension arm for a vehicle to be manufactured in advance, and subsequently performing a hot-pressing on the preform to form the suspension arm for a vehicle. As a result, it is possible to quickly and easily form the suspension arm for a vehicle of a light-weight and relatively high rigidity.

Although a plurality of operations of the method of manufacturing the suspension arm for a vehicle according to an example embodiment of the present disclosure described below have been described in a sequential order, these operations may not be necessarily performed in the sequence described below. For example, the order of some operations may be changed, some of the operations may be omitted, additional operations may be added, or some of the operations may be performed in a simultaneous manner.

As illustrated in FIG. 10, the method of manufacturing the suspension arm for a vehicle according to an example embodiment of the present disclosure may comprise a preform forming operation S100 of forming a preform 100a as a preliminary molding object for forming a suspension arm for a vehicle, and a main-molding-object forming operation S200 of hot-pressing the preform 100a formed in the preform forming operation S100 to form a main molding object for forming the suspension arm for a vehicle.

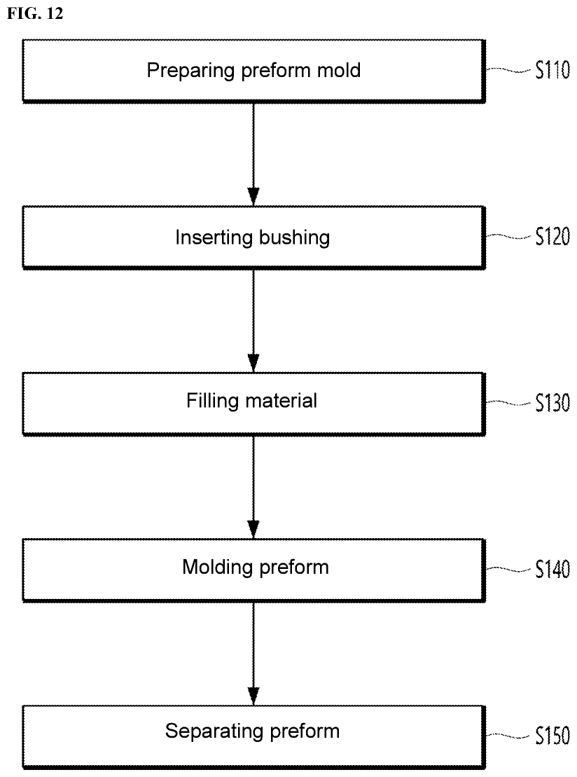

Specifically, in the method of manufacturing the suspension arm for a vehicle according to an example embodiment of the present disclosure, the preform forming operation S100 is an operation of forming the preliminary molding object (preform) to be used in forming the suspension arm for a vehicle according to an example embodiment of the present disclosure. As illustrated in FIG. 12, the preform forming operation S100 may comprise: a preform-mold preparation operation S110 of preparing a preform mold in which a recess having a shape corresponding to a shape of the preform is formed; a material filling operation S130 of filling light-weight carbon-based material or the like into the recess of the preform mold; a preform molding operation S140 of forming the preform by molding the material filled into the recess of the preform mold; and a preform separating operation S150 of separating the molded preform from the preform mold. In order to implement more productive production, the preform forming operation S100 may further comprise inserting a bushing(s) into the recess of the preform mold before the material filling operation S130.

According to an example embodiment of the present disclosure, the preform 100a may be formed in a substantially similar shape to a shape of a main molding object of a suspension arm for a vehicle to be manufactured. The preform 100a may be formed in a shape offset inward from an outer shape of the main molding object by a predetermined dimension when viewed in a direction perpendicular to the body portion of the suspension arm (for example, a direction indicated in FIG. 11A, that is, a direction of pressing the mold at the time of manufacturing the suspension arm for a vehicle).

For example, as illustrated in FIG. 11A, the preform may be formed such that an outer periphery thereof is offset inward from an outer periphery of the main molding object of the suspension arm for a vehicle by a predetermined dimension so as to have a dimension smaller than the outer periphery of the main molding object, and a portion such as a through-hole 240a formed therein is offset inward from a through-hole 240 formed in the main molding object by a predetermined dimension to so as to have a larger size than that of the through-hole 240.

As described above, by forming the preform in a shape offset inward from the outer shape of the main molding object of the suspension arm for a vehicle by the predetermined dimension, the preform may be smoothly inserted into a mold of the main molding object without any interference when forming the main molding object. This makes it possible to perform the manufacturing process of the suspension arm for a vehicle more quickly and easily.

According to an example embodiment of the present disclosure, in order to stably manufacture the suspension arm for a vehicle while minimizing interference between the preform and the main-molding-object, the preform 100a may be formed to have a shape offset inward from the outer shape of the main molding object 100 by 1 mm to 3 mm.

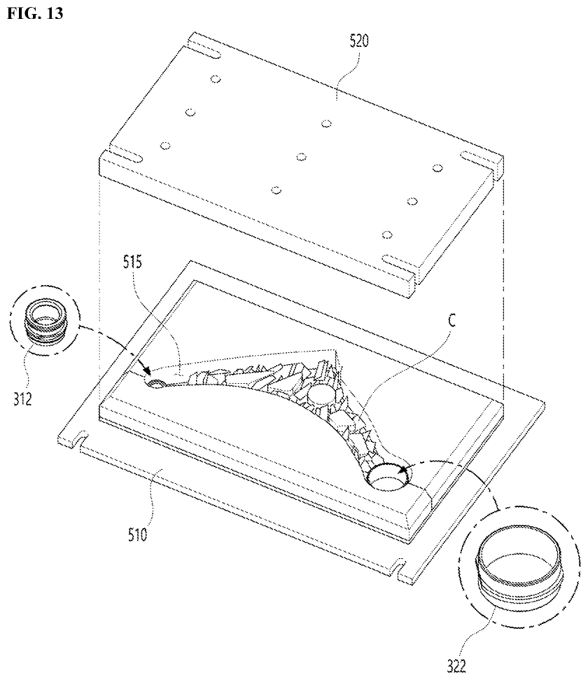

According to an example embodiment of the present disclosure, in the preform-mold preparation operation S110, a preform mold for forming the preform is prepared. As illustrated in FIG. 13, the preform mold may comprise a lower preform mold 510 in which a recess 515 having a shape corresponding to a shape of the preform is formed, and an upper preform mold 520 which presses the lower preform mold 510.

According to an example embodiment of the present disclosure, the recess 515 provided in the lower preform mold 510 may be formed to have an outer periphery having a shape corresponding to the outer periphery of the preform 100a. A central portion of the recess 515 may have a protrusion portion formed to protrude upward to form the through-hole 240a provided in a central portion of the preform 100a.

As described above, the method of manufacturing the suspension arm for a vehicle according to an example embodiment of the present disclosure is configured such that the preform is formed to be offset inward by the predetermined dimension from the main molding object of the suspension arm for a vehicle to be manufactured. Thus, the outer periphery of the recess 515 provided in the lower preform mold 510 may be smaller than the outer periphery of the main molding object, and the protrusion portion or the like for forming the through-hole may be formed at a size larger than that of the through-hole provided in the main molding object.

According to an example embodiment of the present disclosure, in a bushing insertion operation S120, a portion or all of bushings which are to be coupled to the suspension arm for a vehicle (for example, the B-bushing 312 to be coupled to the first mounting portion 310 connected to the wheel-side member, the G-bushing 322 to be coupled to the second mounting portion 320 connected to the vehicle-body-side member, and the like) may be inserted into a predetermined location in the mold. As described above, when the preform is formed in the state in which the portion or all of the bushings provided in the suspension arm for a vehicle are mounted in the recess formed in the preform mold, the preform may be formed while being integrated with the bushings. This further improves productivity of the suspension arm for a vehicle.

However, the method of manufacturing the suspension arm for a vehicle according to an example embodiment of the present disclosure may not comprise the bushing insertion operation S120. Alternatively, the bushing insertion operation S120 may be performed in the main-molding-object forming operation S200 (specifically, before the preform insertion operation S220) rather than the preform forming operation S100.

According to an example embodiment of the present disclosure, in the material filling operation S130, material such as carbon chip C for molding the preform may be filled into the recess 515 provided in the lower preform mold 510. In an example embodiment of the present disclosure, for example, the carbon chip C may be carbon-based material cut in a chip shape of a predetermined size. The carbon chip C may be formed of chip-shaped material having a length of about 10 mm to 150 mm and a width of about 3 mm to 20 mm.

According to an example embodiment of the present disclosure, in the material filling operation S130, a same amount of material as material necessary for forming the main molding object of the suspension arm for a vehicle to be manufactured may be filled into the recess 515 of the preform mold.

As described above, when the preform is formed using the same amount of material (for example, carbon-based material such as carbon chip) as material necessary for forming the main molding object of the suspension arm of a vehicle, a need to fill an additional material into the mold in the subsequent main-molding-object forming operation may be eliminated. This makes it possible to simplify the manufacturing process of the suspension arm for a vehicle and further improve the productivity.

Further, even if the preform 100a used in the method of manufacturing the suspension arm for a vehicle according to an example embodiment of the present disclosure is formed in a shape offset inward from the main molding object 100 of the suspension arm for a vehicle to be manufactured, the preform 100a is formed using the same amount of material as the amount required to form the main molding object. Accordingly, the preform 100a may be formed thicker than a thickness of the main molding object 100 to be manufactured by a predetermined dimension (formed thicker in the direction of pressing the mold), as illustrated in FIG. 10B. For example, according to an example embodiment of the present disclosure, the preform may be formed thicker than the main molding object by 1 mm to 3 mm.

According to an example embodiment of the present disclosure, in the preform molding operation S140, the preform 100a may be formed by molding the material filled into the preform mold at a predetermined temperature and pressure. After the preform is molded, the preform separating operation S150 may be performed to separate the molded preform from the preform mold.

Further, after the preform is molded by the above-described operation, the main-molding-object forming operation S200 of forming the main molding object of the suspension arm for a vehicle with the molded preform, may be performed.

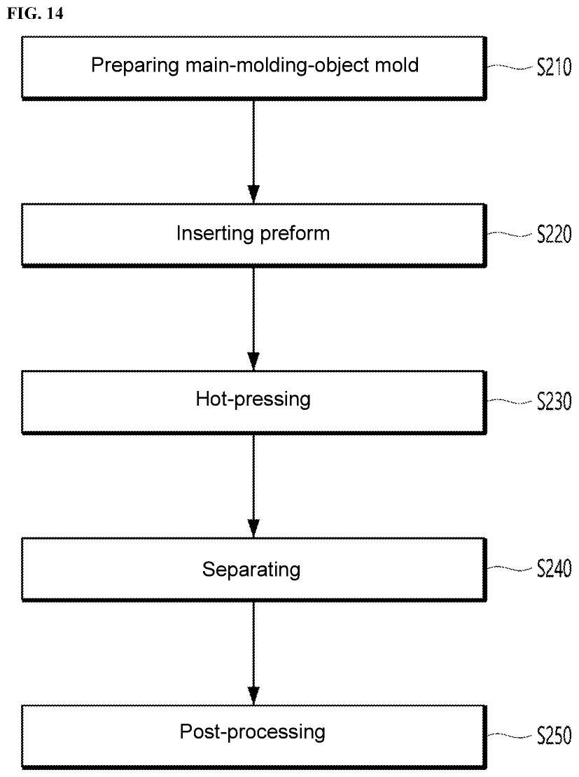

According to an example embodiment of the present disclosure, as illustrated in FIG. 14, the main-molding-object forming operation S200 may comprise: a main-molding-object mold preparation operation S210 of preparing a main-molding-object mold in which a recess having a shape corresponding to the main molding object of the suspension arm for a vehicle to be manufactured is formed; a preform insertion operation S220 of inserting and mounting the preform into and on the recess of the main-molding-object mold; a hot-pressing operation S230 of hot-pressing the preform inserted into the recess of the main-molding-object mold to form the main molding object for manufacturing the suspension arm for a vehicle according to an example embodiment of the present disclosure; and a main-molding-object separating operation S240 of separating the hot-pressed main molding object from the main-molding-object mold.

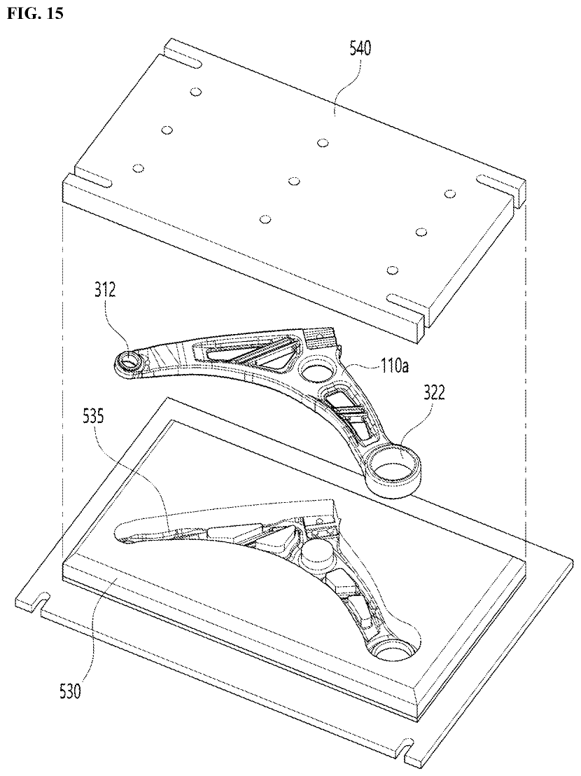

According to an example embodiment of the present disclosure, in the main-molding-object mold preparation operation S210, a main-molding-object mold in which a recess having a shape corresponding to the main molding object of the suspension arm for a vehicle to be manufactured is formed, may be prepared. For example, the main-molding-object mold may comprise a lower main-molding-object mold 530 and an upper main-molding-object mold 540 similarly to the preform mold described above. The lower main-molding-object mold 530 may be provided with a recess 535 having a shape corresponding to the main molding object to be manufactured. According to an example embodiment of the present disclosure, as illustrated in FIG. 15, the recess 535 provided in the lower main-molding-object mold 530 has an outer periphery of a shape corresponding to the main molding object of the suspension arm for a vehicle to be manufactured. One or more protrusion portions for forming the through-hole or the like to be provided in the main molding object may be formed in the recess 535.

According to an example embodiment of the present disclosure, in the preform insertion operation S220, the preform 100a formed in the preform forming operation S100 is inserted into and mounted on the recess 535 formed in the main-molding-object mold. As described above, the preform according to an example embodiment of the present disclosure is formed to have the shape offset inward from the main molding object by the predetermined dimension. Thus, the preform may be easily inserted into the recess 535 of the main-molding-object mold formed in the shape corresponding to the main molding object. For example, an outer periphery of the preform may be formed smaller than an outer periphery of the recess 535 provided in the main-molding-object mold, and the through-hole formed in the central portion of the preform may be formed larger than the protrusion portion provided in the recess 535 of the main-molding-object mold. This makes it possible to easily insert the preform into the recess 535 of the main-molding-object mold without any interference.

According to an example embodiment of the present disclosure, in the hot-pressing operation S230, the preform inserted into the main-molding-object mold may be hot-pressed at a predetermined temperature and pressure (for example, in a high-temperature and high-pressure condition). After the hot-pressing, the main-molding-object separating operation S240 may be performed to separate the hot-pressed main molding object from the main-molding-object mold.

Further, according to an example embodiment of the present disclosure, a post-processing operation S250 of performing a subsequent process(es) such as trimming, machining, or the like to form the demolded main molding object in the final shape of the suspension arm for a vehicle to be manufactured, may be further performed as needed

As described above, when the suspension arm for a vehicle 100 is manufactured by the above-described method of manufacturing the suspension arm for a vehicle according to an example embodiment of the present disclosure, in the case in which the suspension arm for a vehicle 100 is formed with carbon-based material such as carbon chip to reduce the weight of the suspension arm for a vehicle 100, a material filling operation of filling the carbon-based material such as the carbon chip may be merely performed in the operation of forming the preform as a preliminary molding object in a rough shape. Further, the material filling operation, which takes a long period of processing time, may be omitted in a main molding operation of forming a final molded product of the suspension arm for a vehicle. This makes it possible to greatly improve the productivity of the suspension arm for a vehicle.

In addition, the preform used in the method of manufacturing the suspension arm for a vehicle according to an example embodiment of the present disclosure is formed in a shape approximately corresponding to the final shape of the suspension arm for a vehicle as a whole, and the preform is hot-pressed to form the main molding object of the suspension arm of a vehicle to be manufactured. Thus, the suspension arm for a vehicle may have a uniform rigidity as a whole.

In addition, in the method of manufacturing the suspension arm for a vehicle according to an example embodiment of the present disclosure, the preform as a preliminary molding object is formed in a shape corresponding to the main molding object and is formed in a shape offset inward from the outer shape of the main molding object by a predetermined dimension. Thus, when the preform is inserted into the main-molding-object mold to form the main molding object, interference between the preform and the main-molding-object mold may be minimized. This makes it possible to perform the process of manufacturing the suspension arm for a vehicle more quickly and easily.

Further, as in the above-described example embodiments described with reference to FIGS. 3 to 8, in the case in which one of the mounting portions (for example, the third mounting portion 330 in the example embodiments illustrated in FIGS. 3 to 8) is formed separately from the body portion of the suspension arm for a vehicle and then coupled to the body portion of the suspension arm for a vehicle, a mounting-portion coupling operation S300 of coupling the separately-formed mounting portion to the body portion 200 of the suspension arm for a vehicle may be further performed after the main-molding-object forming operation S200.

In this case, as described above, the main molding object for forming the body portion of the suspension arm for a vehicle may be configured such that the coupling portion 210 to which the mounting portion (for example, the third mounting portion 330 in the example embodiments illustrated in FIGS. 3 to 8) is coupled is provided on one side of the body portion. The mounting portion (for example, the third mounting portion 330 in the example embodiments illustrated in FIGS. 3 to 8) may be configured to slidably move and be coupled to the coupling portion 210.

Further, as described above, the slip prevention portion(s) (for example, the protrusion portion and the recess formed to extend in the sliding movement direction) are provided between the mounting portion (for example, the third mounting portion 330 in the example embodiments illustrated in FIGS. 3 to 8) and the coupling portion 210 to support a slidably movable coupling between the third mounting portion 330 and the coupling portion 210, and prevent a slip in a direction intersecting with the sliding movement direction. The fastening members 400 such as locking pins may be fastened to the third mounting portion 330 and the coupling portion 210, which are coupled to each other in the above manner, to support a stable coupling of the third mounting portion 330 to the coupling portion 210.

The structures of these mounting portion and suspension arm for a vehicle may be implemented in the same or similar manner as those in the above-described example embodiments, and thus more detailed descriptions thereof will be omitted.

Further, in the case in which all the plurality of mounting portions used to connect the suspension arm for a vehicle to the wheel-side member or the vehicle-body-side member are formed integrally with the body portion, the mounting-portion coupling operation S300 described above may be omitted.

Although the present disclosure has been described above in terms of specific items such as detailed constituent elements as well as the limited example embodiments, they are merely provided to help more general understanding of the present disclosure, and the present disclosure is not limited to the above example embodiments. Various modifications and changes could have been realized by those skilled in the art to which the present disclosure pertains from the above description.

Therefore, the spirit of the present disclosure need not to be limited to the above-described example embodiments, and in addition to the appended claims to be described below, and all ranges equivalent to or changed from these claims need to be said to belong to the scope and spirit of the present disclosure.

1. A method of manufacturing a suspension arm for a vehicle 100, the method comprising:
a preform forming operation of forming a preform as a preliminary molding object for forming the suspension arm for a vehicle; and
a main-molding-object forming operation of hot-pressing the preform to form a main molding object for forming the suspension arm for a vehicle,
wherein the preform formed in the preform forming operation is formed in a shape corresponding to a shape of the main molding object, and is formed in a shape offset inward from an outer shape of the main molding object by a predetermined dimension.

2. The method of claim 1, wherein the preform formed in the preform forming operation is formed in a shape offset inward from the outer shape of the main molding object by 1 mm to 3 mm.

3. The method of claim 1, wherein the preform formed in the preform forming operation is formed thicker than the main molding object by a predetermined dimension.

4. The method of claim 3, wherein the preform formed in the preform forming operation is formed thicker than the main molding object by 1 mm to 3 mm.

5. The method of claim 3, wherein the preform forming operation comprises:
a preform-mold preparation operation of preparing a preform mold in which a recess having a shape corresponding to a shape of the preform;
a material filling operation of filling material for forming the preform into the recess of the preform mold;
a preform molding operation of molding the material filled into the recess of the preform mold to form the preform; and
a preform separating operation of separating the molded preform from the preform mold.

6. The method of claim 5, wherein in the material filling operation, a same amount of material as material necessary for forming the main molding object is filled into the recess of the preform mold.

7. The method of claim 6, wherein the material filled into the recess of the preform mold to form the preform in the material filling operation is carbon chip material.

8. The method of claim 5, wherein the main-molding-object forming operation comprises:
a main-molding-object mold preparation operation of preparing a main-molding-object mold in which a recess having a shape corresponding a shape of the main molding object;
a preform insertion operation of inserting the preform into the recess of the main-molding-object mold;
a hot-pressing operation of hot-pressing the preform inserted into the recess of the main-molding-object mold to form the main molding object; and
a main-molding-object separating operation of separating the hot-pressed main molding object from the main-molding-object mold.

9. The method of claim 8, wherein the main molding object is formed in a structure that one or more of a plurality of mounting portions, which are used to connect the suspension arm for a vehicle to a wheel-side member or a vehicle-body-side member, are integrally formed with a body portion constituting a main frame of the suspension arm for a vehicle.

10. The method of claim 9, further comprising: a mounting-portion coupling operation of coupling a mounting portion(s), not integrally formed with the body portion of the main molding object, to the body portion.

11. The method of claim 10, wherein the mounting portion not integrally formed with the body portion of the main molding object comprises a bushing coupling portion and a fastening portion formed to extend from the bushing coupling portion to one side, and the fastening portion is coupled to the coupling portion in surface-contact with the coupling portion provided in the body portion of the main molding object.

12. The method of claim 11, wherein a slip prevention portion(s) configured to prevent a slip of the fastening portion relative to the coupling portion is provided between the fastening portion and the coupling portion.

13. The method of claim 11 or 12, wherein the mounting portion comprising the bushing coupling portion and the fastening portion is formed of metallic material.

14. The method of claim 13, wherein the mounting portion comprising the bushing coupling portion and the fastening portion is formed of aluminum material.

15. The method of claim 10, further comprising: a post-processing operation of performing a subsequent process(es) necessary for the main molding object after the main-molding-object forming operation.
